(19) United States
(12) Patent Application Publication
(10) Pub. No.: US 2025/0153301 A1
(43) Pub. Date: May 15, 2025

(54) System of Grinding Jewel, and Method Using Same

(71) Applicant: Guangzhou Xiying Garment Accessories Co., Ltd., Guangzhou (CN)

(72) Inventor: Xiaoxia Xie, Guangzhou (CN)

(21) Appl. No.: 18/941,656

(22) Filed: Nov. 8, 2024

(30) Foreign Application Priority Data
Nov. 9, 2023 (CN) 202311487400.5

(51) Int. Cl. B24B 9/16; B24B 51/00; G06T 7/00

(52) U.S. Cl. CPC B24B 9/16; B24B 51/00; G06T 7/0004

(57) ABSTRACT

The present invention provides a jewel grinding system applied to fields of grinding and processing detection. The jewel grinding system includes a base, a placement rack, a loading robot arm, a movable clamping module, a grinding module, a travel monitoring module, a light spot analysis module, and a control module. An angle of a grinding disc can be freely adjusted to meet different grinding requirements. In addition, a designed first transmission mechanism can achieve transmission to the grinding disc that is flexibly adjusted, and the structure is simple and efficient. By providing the travel monitoring module, a grinding effect can be monitored and measured in real time, which is conducive to intelligently adjust operation of the movable clamping module. Therefore, processing of 36 facets at a crown and a girdle can be well achieved, so that a display effect of 9 hearts and 27 arrows is achieved. Symmetric facets can be grinded at the same time by grinding discs that are symmetrically provided, and thus a grinding efficiency and accuracy are improved. A grinding degree of each facet can be visually and intelligently detected by providing the light spot analysis module. Accurate and rapid mounting can be assisted by providing the loading robot arm.

### FIELD OF THE INVENTION

The present invention relates to a field of grinding and processing detection, and in particular to a jewel grinding system and method.

### DESCRIPTION OF THE RELATED ART

A jewel is a rare item with a specific shape and high light transmittance after being processed from a jewel rough stone. A finished jewel product is finally obtained by designing an angle and a size of each surface to be grinded, and then slowly grinding the surface using a grinding device including a grinding disc in which fine jewel particles are embedded. In a traditional jewel grinding technology an engineer uses a manually adjusted fixing device and a magnifying glass to continuously perform grind and observation on a grinding device. Therefore, a highly skilled engineer is required to grind a product that meets a standard. Since the jewel has a high hardness and a small size, it takes a lot of time to observe and adjust the angle during grinding. In addition, the process takes significant time because the grinding and observation must be performed separately. This leads to low efficiency, and thus it is generally thought that more than half of an expensive cost of a jewel comes from a processing fee. In addition, existing grinding devices are mainly used for grinding of a jewel having 57 facets or a jewel having 58 facets. With these devices, it is impossible to implement grinding of 36 facets at a crown and a girdle of the jewel to achieve a display effect of 9 hearts and 27 arrows.

### SUMMARY OF THE INVENTION

A purpose of the present invention is to provide a jewel grinding system to address deficiencies in jewel grinding and grinding standard detection.

In order to overcome the deficiencies in the related art, the present invention adopts the following technical solution. The jewel grinding system of the invention includes: A jewel grinding system includes: a base; a placement rack and a loading robot arm affixed atop;
a movable clamping module; a grinding module configured to grind a jewel; a travel monitoring module configured to collect image information on a processing station; a light spot analysis module configured to detect a processed jewel; and a control module configured to be connected to a moving module, the movable clamping module, the grinding module, the travel monitoring module, and the loading robot arm in communication. The movable clamping module includes a transfer mechanism, a lifting mechanism, a rotating mechanism, and a clamping mechanism which are sequentially connected, the base is provided with an elevation frame, the transfer mechanism is provided on the elevation frame and configured to drive the clamping mechanism to achieve transverse translation, the lifting mechanism is configured to drive the clamping mechanism to achieve lifting, the rotating mechanism is configured to drive the clamping mechanism to rotate, and the clamping mechanism is configured to clamp and fix a workpiece. The grinding module includes a driving mechanism, a first turntable mechanism, and a second turntable mechanism which are all provided on the base, and the driving mechanism is drivingly connected to the first turntable mechanism and the second turntable mechanism.

Further, the first turntable mechanism includes a fixing frame, a movable frame, a grinding disc, and a first transmission mechanism, the fixing frame is provided on the base, the movable frame is rotatably provided on the fixing frame, the grinding disc is rotatably provided on the movable frame via a first mounting shaft, and two ends of the first transmission mechanism are respectively connected to the grinding disc and the driving mechanism.

Further, the first transmission mechanism includes a first mounting base, a second transmission rod, a second mounting base, a first bevel gear, a second bevel gear, a second mounting shaft, a third bevel gear, a fourth bevel gear, and a belt wheel, the second transmission rod is rotatably provided on the first mounting base, the first bevel gear and the belt wheel are respectively provided at two ends of the second transmission rod, the second bevel gear is fixedly connected to the first mounting shaft of the grinding disc, the second mounting shaft is rotatably provided on the second mounting base, the third bevel gear and the fourth bevel gear are both fixedly provided on the second mounting shaft, the first bevel gear is engaged with the third bevel gear, the second bevel gear is engaged with the fourth bevel gear, and the belt wheel is drivingly connected to the driving mechanism.

Further, the grinding module is further provided with a locking mechanism, the locking mechanism is configured to lock the movable frame and includes a locking block and an adjusting bolt, and the adjusting bolt is provided on the fixing frame, has an end connected to the locking block, and is configured to be rotated to connect the locking block and the movable frame to lock the movable frame.

Further, the travel monitoring module includes a first camera and a background board, the first camera is provided on the base and is configured to be connected to the control module in communication to take an image of a grinding processing station, and the background board is configured to provide a background for an image obtained by the first camera to improve an observation quality of the image obtained by the first camera.

Further, the light spot analysis module includes a second camera, a dark box, and a spotlight, the dark box is provided on the base, the second camera and the spotlight are provided in the dark box, the dark box is provided with a placement hole at a top, and the second camera is configured to be connected to the control module in communication.

The problems of the prior art are also addressed by a method comprised of the following steps:
step S1: placing a rough stone to be processed on a casting mold, then adding a set amount of molten material that is in a liquid state after heating such that the molten material is partially connected to the rough stone, and forming a workpiece after the molten material is solidified and adhered to the rough stone;
step S2: placing a workpiece on a placement rack, and controlling, by a control module, a loading robot arm to clamp the workpiece and then to mount the workpiece on a movable clamping module;
step S3: driving, by the movable clamping module, the workpiece to move to a processing station, then driving the workpiece to descend such that the rough stone is partially brought into contact with grinding discs on both sides to start grinding, causing a lifting mechanism to gradually descend until a grinding depth position is reached during a grinding process to process two opposite main facets at a pavilion, after grinding of one surface to be grinded is completed, transferring, by the movable clamping module, the rough stone to a light spot analysis module to analyze whether the processing of the surface to be grinded is completed, controlling rotation mechanism to drive the clamping mechanism to rotate by an angle of one unit surface to be grinded, grinding a next adjacent surface to be grinded, and repeatedly performing the grinding until processing of all 36 main facets at the pavilion is completed;
step S4: after the processing of the pavilion is completed, heating the workpiece to melt the molten material, separating the molten material from the rough stone, rotating the rough stone by 180 degrees from an initial posture, then placing the rough stone on a placement seat of the casting mold, adding the molten material that is in the liquid state after heating into a trough of the casting mold, adjusting inclination angles of the two grinding discs, and then repeating steps S2 and S3 to grind 36 main facets at a crown; and
step S5: taking out a finished product after the grinding is completed, heating, melting, and removing the molten material to take out a grinded jewel.

The present invention achieves the following beneficial effects.

The angle of the grinding disc can be freely adjusted to meet different grinding requirements. In addition, the designed first transmission mechanism can achieve transmission to the grinding disc that is flexibly adjusted, and the structure is simple and efficient.

By providing the travel monitoring module, a grinding effect can be monitored and measured in real time, which is conducive to visually and quantitatively monitor a grinding degree and is also convenient to intelligently adjust operation of the movable clamping module. Therefore, processing of 36 facets at the crown and a girdle can be well achieved, so that a display effect of 9 hearts and 27 arrows is achieved.

Symmetric facets can be grinded at the same time by grinding discs that are symmetrically provided, and thus a grinding efficiency and accuracy are improved.

A grinding degree of each facet can be visually and intelligently detected by providing the light spot analysis module.

Accurate and rapid mounting can be assisted by providing the loading robot arm.

The molten material and the rough stone are combined by the casting mold, and thus a rough stone that has an irregular shape can be stably clamped. Therefore, the device can adapt to processing of different rough stones and adapt to many processing types.

### BRIEF DESCRIPTION OF THE DRAWINGS

The present invention can be further understood from the following description in conjunction with the accompanying drawings. Components in the drawings are not necessarily to scale, emphasis instead being placed upon showing a principle of an embodiment. In different views, the same reference numeral designates a corresponding part.

FIG. 1 is a schematic structural diagram according to the present invention;

FIG. 2 is a partially enlarged schematic structural diagram of FIG. 1 according to the present invention;

FIG. 3 is a schematic structural diagram of a clamping mechanism according to the present invention;

FIG. 4 is a schematic structural diagram of a first transmission mechanism according to the present invention;

FIG. 5 is a schematic structural diagram of a fixing frame and a movable frame according to the present invention;

FIG. 6 is a schematic structural diagram of a casting mold according to the present invention;

FIG. 7 is a sectional view of the casting mold according to the present invention;

FIG. 8 is a schematic structural diagram when a molten material and a rough stone are combined according to the present invention;

FIG. 9 is a schematic structural diagram of an internal structure of a light spot analysis module according to the present invention;

FIG. 10 is a schematic diagram of a light spot image collected by a second camera;

FIG. 11 is a schematic flowchart of a processing method using this system; and

FIG. 12 shows a top view and a bottom view of a distribution of heart shapes and arrow shapes when a finished jewel product is directly observed.

List of Reference Numerals in the Drawings: 1, base; 2, placement rack; 3, loading robot arm; 4, movable clamping module; 41, transfer mechanism; 42, lifting mechanism; 43, rotating mechanism; 44, clamping mechanism; 441, air supply mechanism; 442, telescopic cylinder; 443, first transmission rod; 444, clamping jaw; 51, driving mechanism; 52, first turntable mechanism; 53, movable frame; 54, fixing frame; 55, grinding disc; 521, second mounting base; 522, first bevel gear; 523, second bevel gear; 524, second mounting shaft; 525, third bevel gear; 526, fourth bevel gear; 527, belt wheel; 53, second turntable mechanism; 6, travel monitoring module; 7, light spot analysis module; 71, second camera; 72, dark box; 73, spotlight.

### DETAILED DESCRIPTION

In order to make the purpose, technical solution, and advantages of the present invention more clear, the present invention is further described in detail with reference to embodiments thereof. It should be understood that the specific embodiments described herein are only used to explain the present invention and are not used to limit the present invention. For a person skilled in the art, another system, method, and/or feature of the embodiment will become apparent after reviewing the following detailed description. It is intended that all such an additional system, a method, a feature, and an advantage are included in this specification, are included within the scope of the present invention, and protected by attached claims. Additional features of a disclosed embodiment are described in the following detailed description, and these features will be apparent from the following detailed description.

The same or similar reference numerals in the drawings in the embodiment of the present invention correspond to the same or similar components. In the description of the present invention, it should be understood that an orientation or position relation indicated by terms “upper”, “lower”, “left”, “right” and the like is based on an orientation or position relation shown in the drawings, and is merely for the convenience of describing the present invention and simplifying the description, rather than indicating or implying that a referred device or component must have a specific orientation, be constructed and operated in a specific orientation. Therefore, the terms describing the position relation in the drawings are only used for illustrative purposes and cannot be understood as a limitation on this patent. For a person skilled in the art, specific meanings of the above terms can be understood according to the specific circumstances.

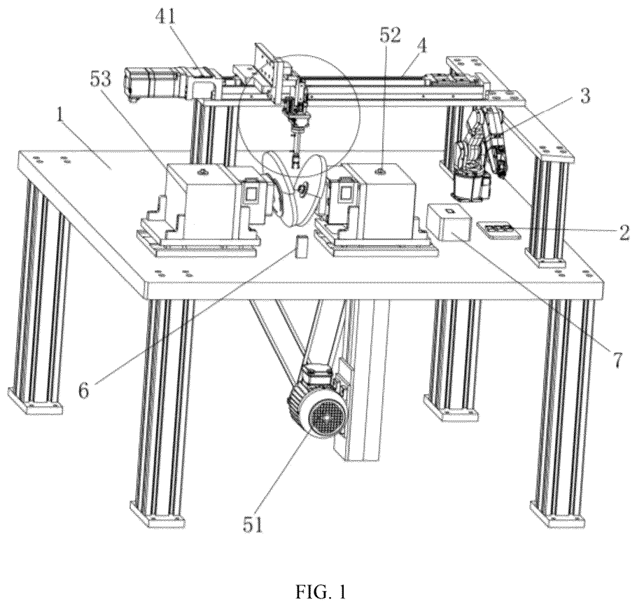

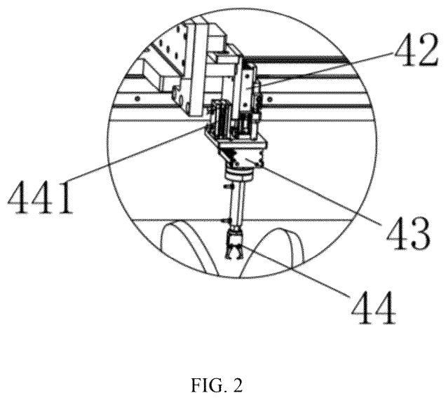

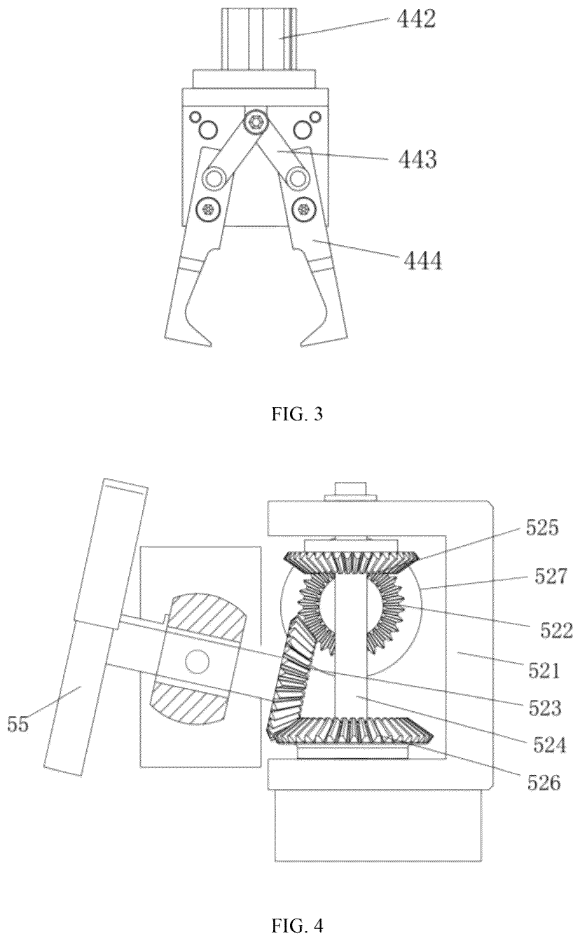

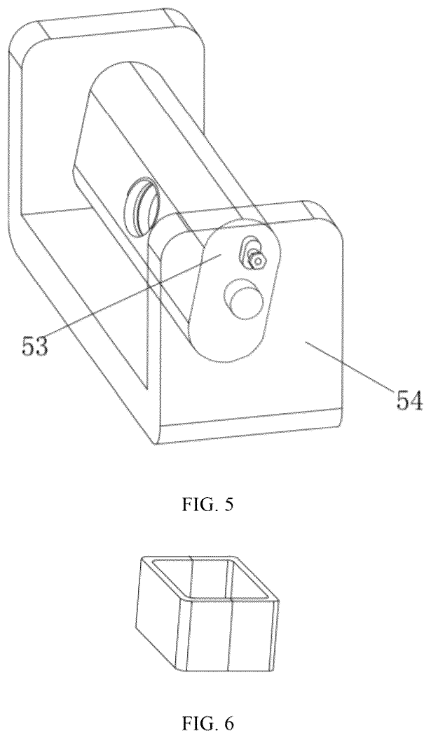

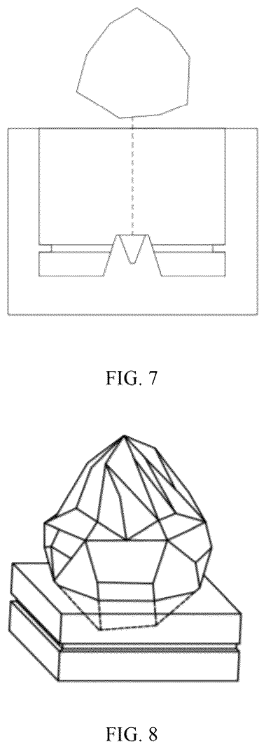

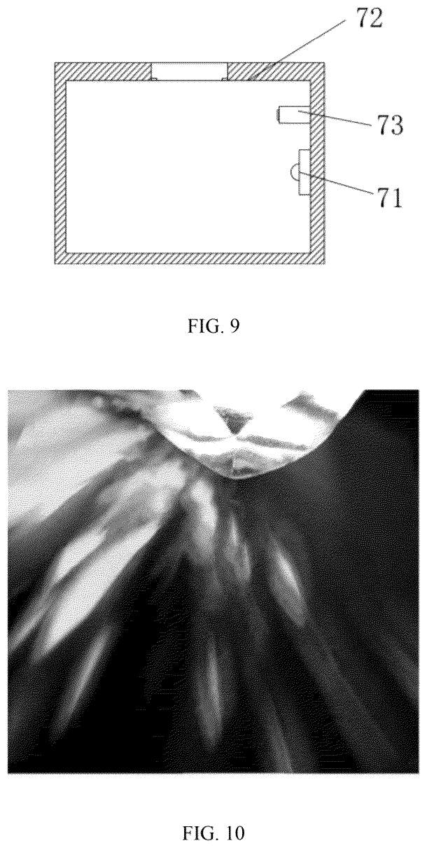

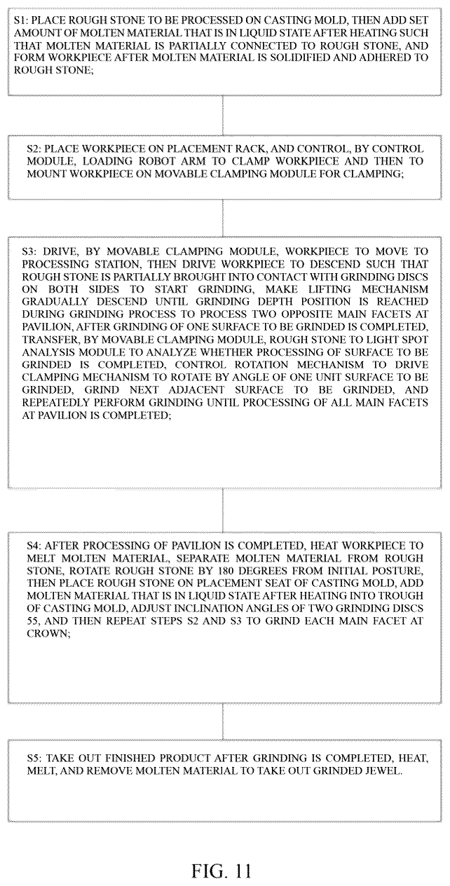

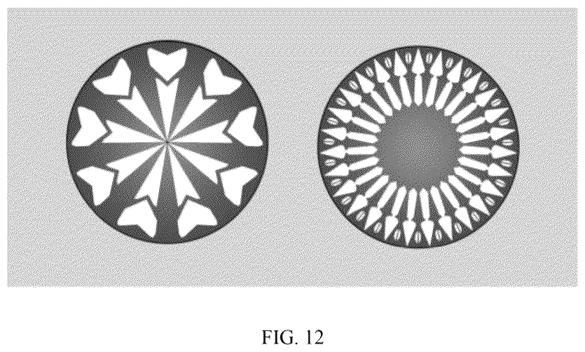

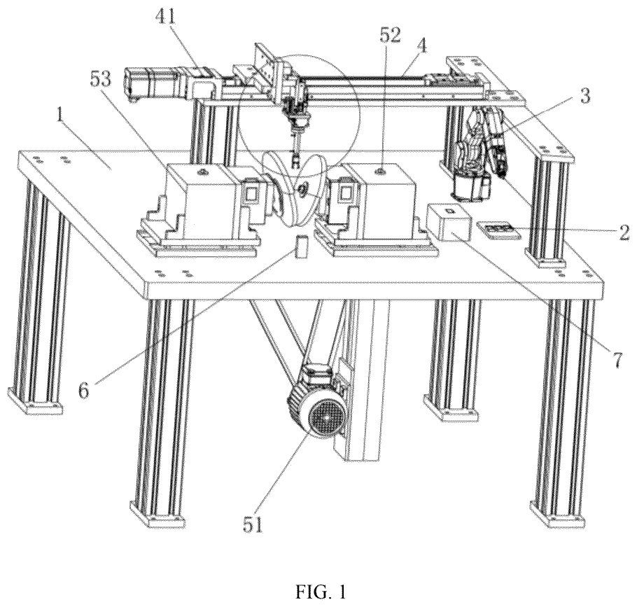

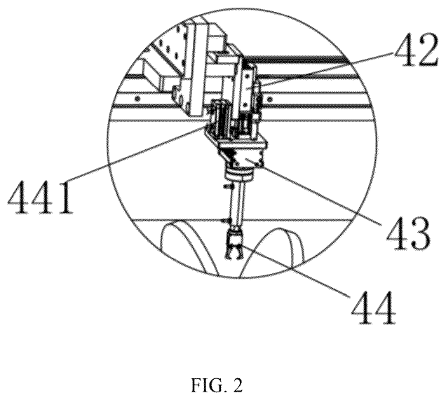

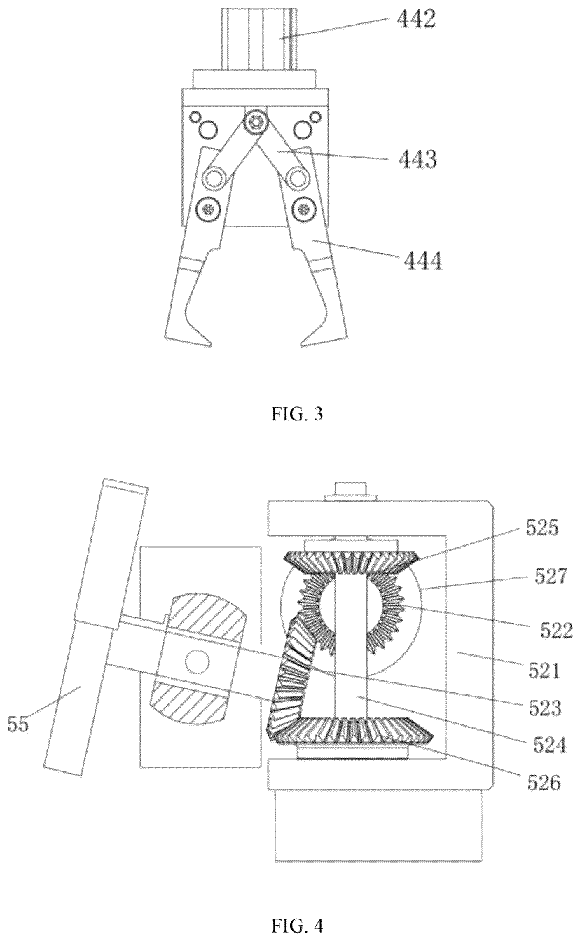

Embodiment 1. As shown in FIGS. 1, 2, 3, and 4, a jewel grinding system includes: a base 1; a placement rack 2 and a loading robot arm 3 that are both provided on the base 1; a movable clamping module 4 configured to drive the movable clamping module 4 to move; a grinding module configured to grind a jewel; a travel monitoring module 6 configured to collect image information on a processing station; a light spot analysis module 7 configured to detect a processed jewel; and a control module configured to be connected to a moving module, the movable clamping module 4, the grinding module, the travel monitoring module 6, and the loading robot arm 3 in communication.

The movable clamping module 4 includes a transfer mechanism 41, a lifting mechanism 42, a rotating mechanism 43, and a clamping mechanism 44 which are sequentially connected. The base 1 is provided with an elevation frame. The transfer mechanism 41 is provided on the elevation frame and is configured to drive the clamping mechanism 44 to achieve transverse translation. The lifting mechanism 42 is configured to drive the clamping mechanism 44 to achieve lifting. The rotating mechanism 43 is configured to drive the clamping mechanism 44 to rotate. The clamping mechanism 44 is configured to clamp and fix a workpiece.

The grinding module includes a driving mechanism 51, a first turntable mechanism 52, and a second turntable mechanism 53 which are all provided on the base 1. The driving mechanism 51 is drivingly connected to the first turntable mechanism 52 and the second turntable mechanism 53.

The first turntable mechanism 52 includes a fixing frame 54, a movable frame 53, a grinding disc 55, and a first transmission mechanism. The fixing frame 54 is provided on the base 1. The movable frame 53 is rotatably provided on the fixing frame 54. The grinding disc 55 is rotatably provided on the movable frame 53 via a first mounting shaft. Two ends of the first transmission mechanism are respectively connected to the grinding disc 55 and the driving mechanism 51.

The first transmission mechanism includes a first mounting base, a second transmission rod, a second mounting base 521, a first bevel gear 522, a second bevel gear 523, a second mounting shaft 524, a third bevel gear 525, a fourth bevel gear 526, and a belt wheel 527. The second transmission rod is rotatably provided on the first mounting base. The first bevel gear 522 and the belt wheel 527 are respectively provided at two ends of the second transmission rod. The second bevel gear 523 is fixedly connected to the first mounting shaft of the grinding disc 55. The second mounting shaft 524 is rotatably provided on the second mounting base 521. The third bevel gear 525 and the fourth bevel gear 526 are both fixedly provided on the second mounting shaft 524. The first bevel gear 522 is engaged with the third bevel gear 525. The second bevel gear 523 is engaged with the fourth bevel gear 526. The belt wheel 527 is drivingly connected to the driving mechanism 51.

The grinding module is further provided with a locking mechanism. The locking mechanism is configured to lock the movable frame 53 and includes a locking block and an adjusting bolt. The adjusting bolt is provided on the fixing frame 54, has an end connected to the locking block, and is configured to be rotated to connect the locking block and the movable frame 53 to lock the movable frame 53.

The travel monitoring module 6 includes a first camera and a background board. The first camera is provided on the base 1, and is configured to be connected to the control module in communication to take an image of a grinding processing station. The background board is configured to provide a background for an image obtained by the first camera to improve an observation quality of the image obtained by the first camera.

The light spot analysis module 7 includes a second camera 71, a dark box 72, and a spotlight 73. The dark box 72 is provided on the base 1. The second camera 71 and the spotlight 73 are provided in the dark box 72. The dark box 72 is provided with a placement hole at a top. The second camera 71 is configured to be connected to the control module in communication.

The control module includes an analysis unit configured to process, compare, and analyze images collected by the first camera and the second camera 71.

Regarding Embodiment 2, this embodiment further describes the above embodiment. It should be understood that this embodiment includes all the above technical features and performs further specific description.

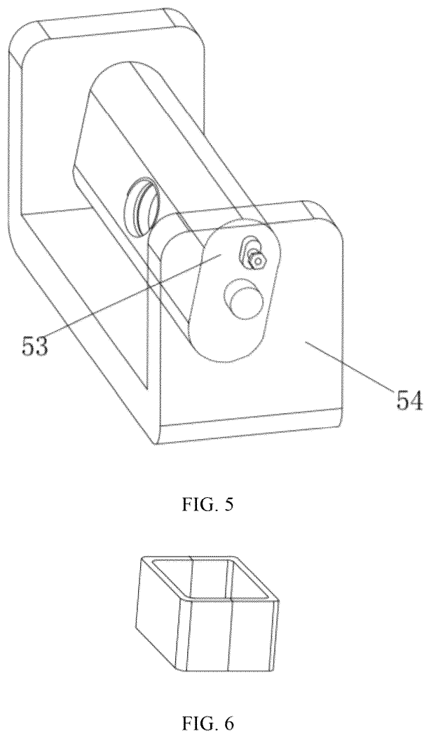

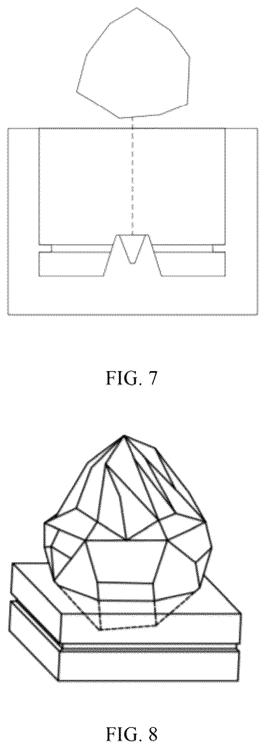

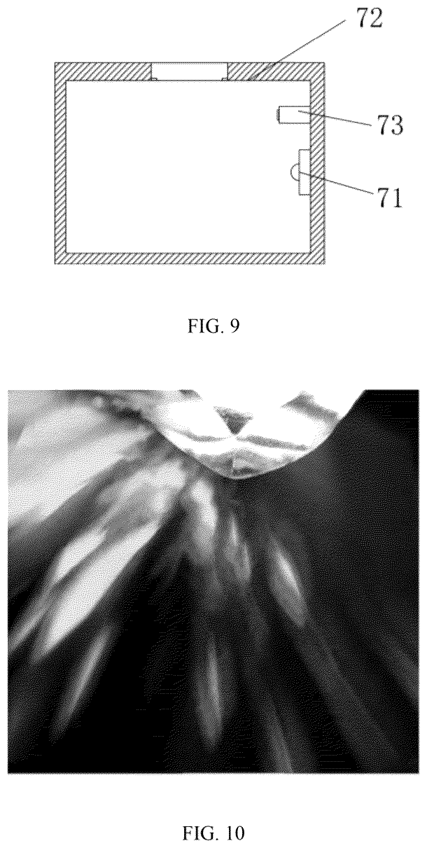

As shown in FIGS. 5, 6, 7, 8 and 9, the transfer mechanism 41 is configured as a screw slider module. The lifting mechanism 42 is configured as a structure of a telescopic cylinder 442. The rotating mechanism 43 is configured as a rotating cylinder.

The clamping mechanism 44 includes an air supply mechanism 441, the telescopic cylinder 442, first transmission rods 443, and clamping jaws 444. The air supply mechanism 441 communicates with the telescopic cylinder 442 via a conduit. The clamping jaw 444 is drivingly connected to a piston rod of the telescopic cylinder 442 via the first transmission rod 443. The two clamping jaws 444 are configured to be driven by a reciprocating motion of the piston rod of the telescopic cylinder 442 to release by opening and clamp by closing.

An aperture of the placement hole matches a cross-sectional shape of a trough of a casting mold.

The movable frame 53 is provided with an angle mark. The fixing frame 54 is provided with an observation hole corresponding to the angle mark. The angle mark is used for displaying an inclination angle between the movable frame 53 and the fixing frame 54.

A distance adjusting mechanism is also provided on the base 1 and is used to adjust a distance between the first turntable mechanism 52 and the second turntable mechanism 53.

The distance adjusting mechanism is configured as a screw slider module.

Two or more locking mechanisms are provided.

The casting mold is formed by splicing two half-molds having the same shape, and includes the trough, a storage seat, and a convex ring portion.

A structure of the second turntable mechanism 53 is the same as that of the first turntable mechanism 52, and the second turntable mechanism 53 and the first turntable mechanism 52 are provided on the base 1 in opposite directions.

The driving mechanism 51 includes a first motor, a first transmission belt, and a second transmission belt. The first motor is drivingly connected to the belt wheels 527 of the first turntable mechanism 52 and the second turntable mechanism 53 via the first transmission belt and the second transmission belt respectively.

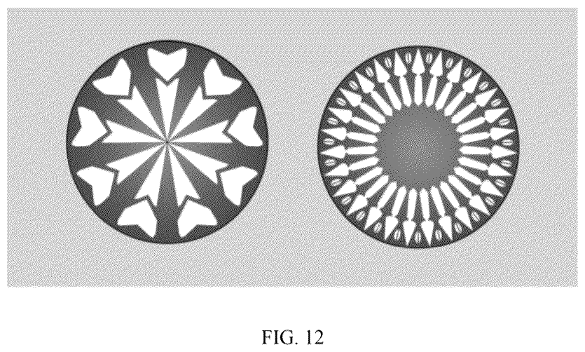

An angle of the grinding disc 55 designed in this system can be freely adjusted to meet different grinding requirements. In addition, the designed first transmission mechanism can achieve transmission to the grinding disc 55 that is flexibly adjusted, and the structure is simple and efficient. By providing the travel monitoring module 6, a grinding effect can be monitored and measured in real time, which is conducive to intelligently adjust operation of the movable clamping module 4. As shown in FIG. 12, processing of 36 facets at a crown and a girdle can be well achieved, so that a display effect of 9 hearts and 27 arrows is achieved. Symmetric facets can be grinded at the same time by the grinding discs 55 that are symmetrically provided, and thus a grinding efficiency and accuracy are improved. A grinding degree of each facet can be visually and intelligently detected by providing the light spot analysis module 7. Accurate and rapid mounting can be assisted by providing the loading robot arm 3. A molten material and a rough stone are combined by the casting mold, and thus a rough stone that has an irregular shape can be stably clamped. Therefore, the device can adapt to processing of different rough stones and adapt to many processing types.

Regarding Embodiment 3, this embodiment further describes the above embodiment. It should be understood that this embodiment includes all the above technical features and performs further specific description.

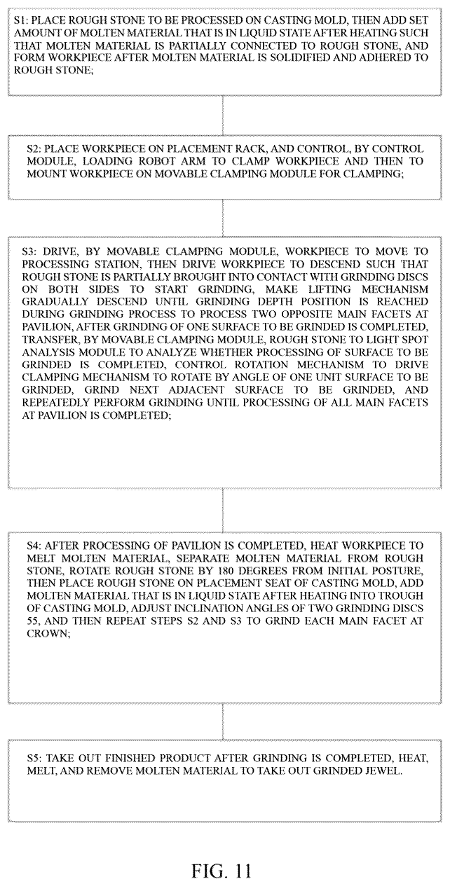

As shown in FIG. 11, A method of jewel grinding includes the following steps S1 to S5.

In step S1, a rough stone to be processed is placed on the casting mold. Then, a set amount of molten material that is in a liquid state after heating is added such that the molten material is partially connected to the rough stone. A workpiece is formed after the molten material is solidified and adhered to the rough stone.

In step S2, the workpiece is placed on the placement rack 2. The control module controls the loading robot arm 3 to clamp the workpiece and then to mount the workpiece on the movable clamping module 4 for clamping.

As a clamping manner of the movable clamping module 4, the molten material forms a limiting recess at the convex ring portion of the casting mold, and the clamping mechanism 44 clamps and clips the workpiece into the limiting recess. Therefore, the workpiece can be clamped and fixed.

In step S3, the movable clamping module 4 drives the workpiece to move to a processing station, and then drives the workpiece to descend such that the rough stone is partially brought into contact with the grinding discs 55 on both sides to start grinding. A lifting mechanism gradually descends until a grinding depth position is reached during a grinding process to process two opposite main facets at a pavilion. After grinding of one surface to be grinded is completed, the movable clamping module 4 transfers the rough stone to the light spot analysis module 7 to analyze whether the processing of the surface to be grinded is completed. Rotation is controlled to drive the clamping mechanism 44 to rotate by an angle of one unit surface to be grinded. A next adjacent surface to be grinded is grinded. The grinding is repeatedly performed until processing of 36 main facets at the pavilion is completed.

As shown in FIG. 10, an analysis manner of the light spot analysis module 7 is as follows. After grinding of one surface to be grinded is completed, the movable clamping module 4 transfer the rough stone to the light spot analysis module 7, makes the workpiece face the placement hole of the dark box 72, and moves a rough stone part of the workpiece such that the rough stone part enters the dark box 72 from the placement hole. Then, the spotlight 73 irradiates the workpiece. Light spots transmitted from the rough stone part are formed on an inner wall of the dark box 72. The light spots on the inner wall are imaged and collected by the second camera 71. A light spot image is collected and then sent to the analysis unit of the control module for comparison and analysis. Whether the light spot image has light spots having specific shapes and sizes is analyzed and compared, and if yes, it is determined that the grinding of the surface is completed.

In step S4, after the processing of the pavilion is completed, the workpiece is heated such that the molten material is melt and separated from the rough stone. The rough stone is rotated by 180 degrees from an initial posture, and then is placed on a placement seat of the casting mold. The molten material that is in the liquid state after heating is added into the trough of the casting mold. Inclination angles of the two grinding discs 55 are adjusted, and then steps S2 and S3 are repeated to grind 36 main facets at the crown.

In step S5, a finished product is taken out after the grinding is completed, and the molten material is heated, melted, and removed to take out a grinded jewel.

Although the present invention has been described above with reference to various embodiments, it should be understood that many changes and modifications may be made without departing from the scope of the present invention. That is, the method, system, and devices discussed above are examples. Various processes or components may be suitably omitted, replaced, or added in various configurations. For example, in an alternative configuration, the method may be performed in an order different from that described, and/or various components may be added, omitted, and/or combined. Moreover, the features described with respect to certain configurations may be combined in various other configurations, such as different aspects and elements of the configurations may be combined in a similar manner. In addition, the elements therein may be updated as technology develops, i.e., many elements are examples and do not limit the scope of the present disclosure or claims.

Specific details are given in the specification to provide a thorough understanding of the exemplary configurations including implementations. However, the configurations may be practiced without these specific details. For example, well-known circuits, processes, algorithms, structures, and techniques have been shown without unnecessary detail to avoid obscuring the configurations. This description only provides the exemplary configurations and does not limit the scope, applicability, or configurations of the claims. Rather, the above description of the configurations will provide, for a person skilled in the art, an enabling description for implementing the described techniques. Various changes may be made to the function and arrangement of elements without departing from the spirit or scope of the present disclosure. In summary, it is intended that the above detailed description is considered to be illustrative rather than restrictive, and it should be understood that the above embodiments are merely used to illustrate the present invention and not to limit the scope of the present invention. After reading the contents described in the present invention, a person skilled in the art can make various changes or modifications to the present invention, and these equivalent changes and modifications also fall within the scope defined by the claims of the present invention.

1. A jewel grinding system, comprising:
a base;
a placement rack and a loading robot arm affixed atop the base;
a movable clamping module;
a grinding module configured to grind a jewel;
a travel monitoring module configured to collect image information on a processing station;
a light spot analysis module configured to detect a processed jewel; and
a control module configured to be connected to a moving module, the movable clamping module, the grinding module, the travel monitoring module, and the loading robot arm in communication, wherein
the movable clamping module includes a transfer mechanism, a lifting mechanism, a rotating mechanism, and a clamping mechanism which are sequentially connected, the base is provided with an elevation frame, the transfer mechanism is provided on the elevation frame and configured to drive the clamping mechanism to achieve transverse translation, the lifting mechanism is configured to drive the clamping mechanism to achieve lifting, the rotating mechanism is configured to drive the clamping mechanism to rotate, and the clamping mechanism is configured to clamp and fix a workpiece, and the grinding module includes a driving mechanism, a first turntable mechanism, and a second turntable mechanism which are all provided on the base, and the driving mechanism is drivingly connected to the first turntable mechanism and the second turntable mechanism.

2. The jewel grinding system according to claim 1, wherein
the first turntable mechanism includes a fixing frame, a movable frame, a grinding disc, and a first transmission mechanism, the fixing frame is provided on the base, the movable frame is rotatably provided on the fixing frame, the grinding disc is rotatably provided on the movable frame via a first mounting shaft, and two ends of the first transmission mechanism are respectively connected to the grinding disc and the driving mechanism.

3. The jewel grinding system according to claim 2, wherein
the first transmission mechanism includes a first mounting base, a second transmission rod, a second mounting base, a first bevel gear, a second bevel gear, a second mounting shaft, a third bevel gear, a fourth bevel gear, and a belt wheel, the second transmission rod is rotatably provided on the first mounting base, the first bevel gear and the belt wheel are respectively provided at two ends of the second transmission rod, the second bevel gear is fixedly connected to the first mounting shaft of the grinding disc, the second mounting shaft is rotatably provided on the second mounting base, the third bevel gear and the fourth bevel gear are both fixedly provided on the second mounting shaft, the first bevel gear is engaged with the third bevel gear, the second bevel gear is engaged with the fourth bevel gear, and the belt wheel is drivingly connected to the driving mechanism.

4. The jewel grinding system according to claim 3, wherein
the grinding module is further provided with a locking mechanism, the locking mechanism is configured to lock the movable frame and includes a locking block and an adjusting bolt, and the adjusting bolt is provided on the fixing frame, has an end connected to the locking block, and is configured to be rotated to connect the locking block and the movable frame to lock the movable frame.

5. The jewel grinding system according to claim 4, wherein
the travel monitoring module includes a first camera and a background board, the first camera is provided on the base, and is configured to be connected to the control module in communication to take an image of a grinding processing station, and the background board is configured to provide a background for an image obtained by the first camera to improve an observation quality of the image obtained by the first camera.

6. The jewel grinding system according to claim 5, wherein
the light spot analysis module includes a second camera, a dark box, and a spotlight, the dark box is provided on the base, the second camera and the spotlight are provided in the dark box, the dark box is provided with a placement hole at a top, and the second camera is configured to be connected to the control module in communication.

7. The jewel grinding system according to claim 1, wherein
the control module includes an analysis unit configured to process, compare, and analyze images collected by a first camera and a second camera.

8. A method of jewel grinding, the method comprising:
placing a rough stone to be processed on a casting mold, then adding a set amount of molten material that is in a liquid state after heating such that the molten material is partially connected to the rough stone, and forming a workpiece after the molten material is solidified and adhered to the rough stone;
placing the workpiece on a placement rack, and controlling, by a control module, a loading robot arm to clamp the workpiece and then to mount the workpiece on a movable clamping module;
driving, by the movable clamping module, the workpiece to move to a processing station, then driving the workpiece to descend such that the rough stone is partially brought into contact with grinding discs on both sides to start grinding, causing a lifting mechanism to gradually descend until a grinding depth position is reached during a grinding process to process two opposite main facets at a pavilion, after grinding of one surface to be grinded is completed, transferring, by the movable clamping module, the rough stone to a light spot analysis module to analyze whether the processing of the surface to be grinded is completed, controlling rotation mechanism to drive the clamping mechanism to rotate by an angle of one unit surface to be grinded, grinding a next adjacent surface to be grinded, and repeatedly performing the grinding until processing of all 36 main facets at the pavilion is completed;
after the processing of the pavilion is completed, heating the workpiece to melt the molten material, separating the molten material from the rough stone, rotating the rough stone by 180 degrees from an initial posture, then placing the rough stone on a placement seat of the casting mold, adding the molten material that is in the liquid state after heating into a trough of the casting mold, adjusting inclination angles of the two grinding discs, and then repeating steps S2 and S3 to grind 36 main facets at a crown; and
taking out a finished product after the grinding is completed, heating, melting, and removing the molten material to take out a grinded jewel.
